(19) United States
(12) Patent Application Publication
(10) Pub. No.: US 2026/0329231 A1
(43) Pub. Date: Oct. 22, 2026

(54) BIDIRECTIONAL CORRECTION DEVICE AND TIMEPIECE MOVEMENT COMPRISING SUCH A DEVICE

(71) Applicant: Richemont International SA, VILLARS-SUR-GLANE (CH)

(72) Inventor: Samuel VUILLEMEZ, Le Cerneux-Péquignot (CH)

(21) Appl. No.: 19/105,884

(22) PCT Filed: Aug. 8, 2023
(86) PCT No.: PCT/EP2023/071974

§ 371 Date: Feb. 24, 2025

(30) Foreign Application Priority Data
Aug. 29, 2022 (EP) 22192702.3

(51) Int. Cl. G04B 19/25; G04B 27/00

(52) U.S. Cl. CPC G04B 19/25; G04B 27/004

(57) ABSTRACT

A device for the bidirectional correction of at least two displays of a display device having a correction mobile and a correction gear train arranged to simultaneously correct the at least two displays of a calendar display device independently with respect to a force transmission mechanism of the at least two displays in order to preserve the synchronisation of the at least two displays of the display device during the correction phases.

### TECHNICAL FIELD OF THE INVENTION

The present invention relates to a bidirectional correction device for a timepiece movement for the correction of at least two displays of a calendar display device.

### TECHNICAL BACKGROUND OF THE INVENTION

Unidirectional correction mechanisms used to correct for example the date display by means of a control member such as a crown, pusher or corrector have already been proposed. Generally, the correction mechanisms comprise a gear train which meshes or engages with the finishing gear train of the timepiece movement. Examples of such mechanisms are disclosed in documents EP 3 333 642, EP 2 945 024, EP 1 043 634 and CH 703 451.

A calendar module is generally used to adapt to several different timepiece movements while allowing a sophisticated calendar display such as an annual or perpetual date display and/or with other displays such as the week day, the week number, the month, the year and/or the moon phase.

However, it is difficult depending on the meshing of the calendar displays with the timepiece movement to simultaneously correct several displays at any time of the day and bidirectionally.

### SUMMARY OF THE INVENTION

The invention aims to propose a new correction device configuration allowing the bidirectional correction of at least two displays including a date display and being compatible with the calendar complications such as the annual, perpetual or secular date.

Thus, the invention relates to a device for the bidirectional correction of at least two displays including a date display of a calendar display device having a correction mobile and a correction gear train permanently coupled to the correction mobile that are arranged to simultaneously correct the at least two displays of the calendar display device independently with respect to a force transmission mechanism of the at least two displays intended to increment them periodically in order to preserve the synchronisation of the at least two displays of the calendar display device during the correction phases.

Advantageously according to the invention, the correction system does not act on the force transmission mechanism coupled to the timepiece movement in the usual way but has its own kinematic chain acting on the calendar display device so that it can adapt to a very large variety of calendar display devices (including stacked calendar modules) and in particular a large variety of calendar display complications. This also provides a means of not desynchronising the displays corrected together. In addition, the correction device according to the invention can therefore advantageously be installed in a timepiece movement or in a calendar module intended to be mounted on different types of timepiece movement to display calendar values. Lastly, the correction device can be used to increase as well as decrease the values of at least two displays simultaneously.

The invention therefore also relates to a timepiece movement characterised in that it comprises a device for the bidirectional correction of the display device as described above, the timepiece movement having a force transmission mechanism comprising a date control pin arranged to control a date wheel of a calendar display device to increment by one unit the date display every twenty-four hours, and in that the correction mobile of the bidirectional correction device is arranged to control the date wheel of the calendar display device independently with respect to the force transmission mechanism to avoid disturbing the latter during the correction phases.

The invention may also comprise one or more of the following optional characteristics, taken alone or in combination.

The date control pin can be elastically arranged in the force transmission mechanism so that it can elastically retract from the date wheel when the latter is moved by the correction mobile while the date control pin is on the trajectory of the date wheel. This configuration provides a means of not preventing the correction between eleven p.m. and one a.m. every day. Although this function is not essential since corrections are rarely made at this time of night, it is proposed as an advantageous option of the invention to avoid, for example, desynchronisation of the displays and also to protect the other teeth in contact.

According to a particular variant in which the calendar display device comprises a weekday display as other corrected display, the force transmission mechanism can comprise a day control pin arranged to control a day wheel of the calendar display device to increment by one unit at least one day display every twenty-four hours, the correction gear train of the bidirectional correction device being arranged to control the day wheel of the calendar display device independently with respect to the force transmission mechanism to avoid disturbing the latter during the correction phases.

Advantageously according to the invention, even in this particular variant in which the calendar display device comprises a weekday display as other corrected display, the correction device does not act on the force transmission mechanism coupled to the timepiece movement in the usual way but has its own kinematic chain acting on the calendar display device so that it can adapt to a very large variety of calendar display devices. In addition, the correction device can be used to increase as well as decrease the value of the weekday display at the same time as that of the date display.

The day control pin can be elastically arranged in the force transmission mechanism so that it can elastically retract from the day wheel when the latter is moved by the correction gear train while the day control pin is on the trajectory of the day wheel. This configuration provides a means of not preventing the correction between eleven p.m. and one a.m. every day. Although this function is not essential since, as mentioned above, corrections are rarely made at this time of night, it is proposed as an advantageous option of the invention.

According to a particular variant in which the calendar display device comprises an annual, perpetual or secular date mechanism which comprises various displays including the other corrected display, the force transmission mechanism can comprise a month end control wheel arranged to control a month end wheel of the calendar display device to increment by at least one additional unit the date display depending on the number of days in the month, the correction gear train of the bidirectional correction device being arranged to control the month end wheel of the calendar display device independently with respect to the force transmission mechanism to avoid disturbing the latter during the correction phases.

Advantageously according to the invention, even in this particular variant in which the calendar display device comprises an annual or perpetual date display, the correction system does not act on the force transmission mechanism coupled to the timepiece movement in the usual way but has its own kinematic chain acting on the calendar display device so that it can adapt to a very large variety of calendar display devices. In addition, the correction device can be used to increase as well as decrease the value of the annual, perpetual or secular date display without desynchronising it.

The correction mobile can comprise an elastic force limitation mechanism to elastically disengage the correction movement bidirectionally above a predetermined torque applied to the correction mobile so that the correction gear train does not drive the month end wheel of the calendar display device while the month end control wheel is meshed with the month end wheel of the calendar display device. This configuration avoids damaging the timepiece movement by allowing the correction to be disengaged between midnight and three a.m. at the end of February, April, June, September and November. Although this function is not essential (correction is not possible as resistance to the correction is encountered due to the month end control wheel which is meshed with the month end wheel of the calendar display device) since corrections are rarely made at this time of night, it is proposed as an advantageous option of the invention which dissuades the user from forcing the control member such as a crown.

The bidirectional correction device can comprise a clutch mechanism to switch between a correction position in which the correction device is coupled to a correction control member to correct the display device bidirectionally, and a disengaged position in which the correction device is uncoupled from the control member to prevent any correction of the display device.

The correction device can comprise a cam—elastic element assembly allowing, in the disengaged position, the correction mobile to be in a predetermined rest position outside the trajectory of the date wheel. The cam can for example be mounted on the correction mobile and the elastic element, mounted on a fixed part of the timepiece movement, exerts a thrust force against an external profile of the cam to drive, in the disengaged position, the correction mobile to its predetermined rest position.

We therefore understand that, in the disengaged position, the correction mobile is still in the same rest position, for example to provide an equivalent displacement for the increase (first direction of movement) as for the decrease (second direction of movement opposite to the first direction) of the value of the calendar display.

Lastly, the invention relates to a timepiece characterised in that it comprises a timepiece movement as described above.

### BRIEF DESCRIPTION OF THE DRAWINGS

Other features and advantages of the invention will appear clearly on reading the description which follows, given by way of example and not limiting in any way, referring to the attached drawings, in which:

FIG. 1 is a schematic view of an example of a timepiece according to the invention;

FIG. 2 is a perspective view of a calendar module comprising an example of a correction device according to the invention;

FIG. 3 is a view similar to FIG. 2 in which elements have been removed to make the invention easier to understand;

FIG. 4 is a perspective view of the example of a correction device according to the invention;

FIG. 5 is a perspective view from above of a month end control wheel superimposed on an element of an example of a correction gear train according to the invention;

FIG. 6 is a perspective view from below of a month end control wheel with an elastic control pin superimposed on an element of the example of a correction gear train according to the invention;

FIG. 7 is a perspective view from below of an example of a correction mobile according to the invention.

### DETAILED DESCRIPTION OF AT LEAST ONE EMBODIMENT OF THE INVENTION

On the various figures, elements which are identical or similar have the same references, possibly with an index added. Their structures and functions are therefore not systematically described.

In the remainder of the document, the orientations are the orientations of the figures. In particular, the terms “upper”, “lower”, “left”, “right”, “above”, “below”, “forward” and “backward” generally mean with respect to the direction of representation of the figures. The term “horizontal” therefore means a direction parallel to the main cross-section of the plate of the timepiece movement and the term “vertical” means a direction perpendicular to the horizontal direction and parallel to the thickness of the plate of the timepiece movement.

In the present description, to clarify the explanation of the invention, axes (A1, A2, etc.) are declared arbitrarily as a first axis, a second axis, etc. This is a simple designation to differentiate between non-identical geometric elements and name them. This designation does not imply a priority of one axis over another and it is quite possible to interchange such names without departing from the scope of the present description. Similarly, this designation does not imply an order, in other words a third axis could be used without the need for a first axis and/or a second axis to implement the invention.

“Fixed part” means all the elements or members fixed with respect to a given reference frame such as for example with respect to the calendar wheel or the timepiece movement, in other words static with respect to the board of the calendar module (or the actual board of the calendar module) or static with respect to the plate of the timepiece movement (or the actual plate of the timepiece movement).

“Bidirectional correction device 21” means all the types of device capable of simultaneously modifying at least two calendar displays to increase their value as well as to decrease their value. This device is extremely advantageous since, depending on when the correction is made, it may be faster to decrease the days, date and month of the display device rather than the opposite.

According to the invention, the bidirectional correction device 21 comprises, in the usual way, a clutch mechanism (not shown) to reversibly switch between a correction position in which the correction device 21 is coupled to a correction control member 4 to correct the display device 11 bidirectionally, and a disengaged position in which the correction device 21 is uncoupled from the control member 4 to prevent any correction of the display device 11.

For example, the clutch mechanism used for the invention is of the setting lever—sliding pinion—setting wheel type like that disclosed in Chapter 3.2.7 entitled “winding and setting the hands” from the book “the theory of horology”, Charles-André REYMONDIN et al., Fédération des Écoles techniques (FET), July 2015, ISBN 2-940025-49-5. The setting lever—sliding pinion—setting wheel designations of the clutch release mechanism have been taken from this chapter 3.2.7.

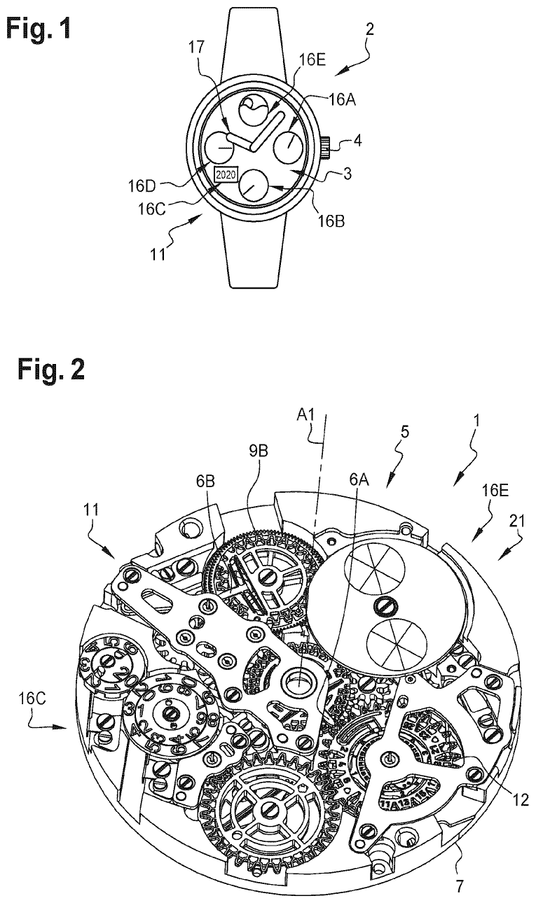

There may be different types of correction control member 4, such as a stem (which can be the same as that used to correct the time and the winding stem) extended by a crown as in the example of FIG. 1, a rotating bezel, two pushers (one to increase the display value and the other to decrease the display value) or a rotating face.

“Independently with respect to the force transmission mechanism 5” means according to the invention that there is no direct coupling between the kinematic chains of the correction device 21 and the force transmission mechanism 5 although each one is adapted to control for example the same date wheel 12 of the calendar display device 11.

“Timepiece 2” means all types of instrument for measuring or counting time such as clocks, small clocks, watches, etc.

“Timepiece movement 3” means all types of mechanism capable of counting time, whether powered by mechanical energy (for example a barrel) or electrical energy (for example a battery).

“Calendar module 1” means a sub-assembly intended to be attached to a timepiece movement 3 to add thereto at least one additional calendar display function. The calendar module 1 can comprise several components allowing a calendar display from the simplest to the most sophisticated such as a simple, annual, perpetual or secular date display and/or with other displays such as the week day, the week number, the month, the year, the day-night or morning/afternoon display and/or all types of moon phase (moon displayed from the north or south hemisphere or moon displayed for the north and south hemispheres).

In the example shown on FIGS. 1 and 2, the invention relates to a correction device 21 mounted in a calendar module 1 intended to be mounted on a timepiece movement 3 in a timepiece 2. Obviously, the correction device 21 according to the invention can be applied, more generally, to any timepiece movement 3 without departing from the scope of the invention and not only to a calendar module 1. However, the invention is explained below in the particular embodiment where the correction device 21 is installed in a calendar module 1.

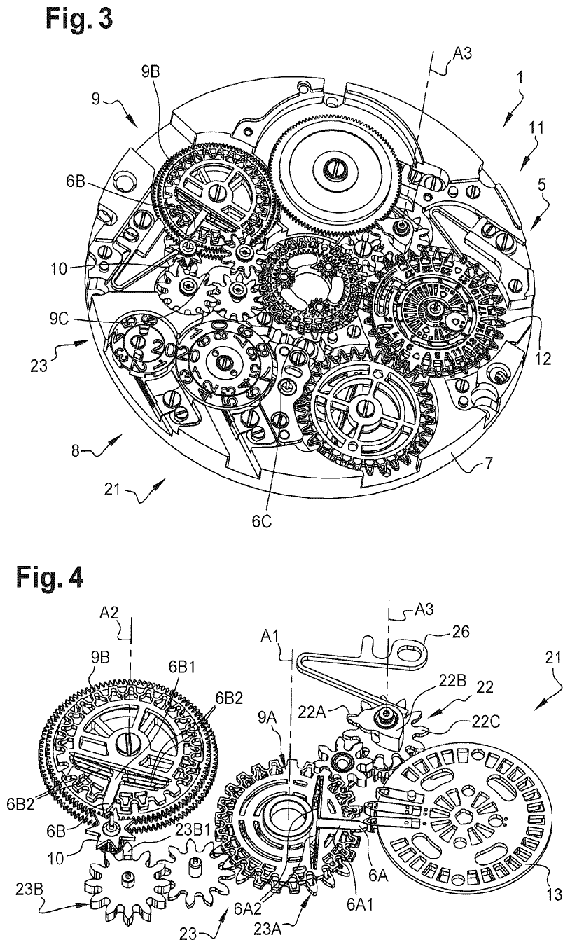

In the example shown on FIGS. 2 and 3, the calendar module 1 is coupled at the centre of its board 7 to an output shaft (not shown) of the timepiece movement 3 such as that attached, preferably, to the hour wheel. The output shaft (not shown) of the timepiece movement 3 is thus permanently coupled to a force transmission mechanism 5 intended to drive the calendar display device 11. Obviously, other output shafts of the timepiece movement 3 centred or not on the board 7 can be selected without departing from the scope of the invention.

As will be explained below, the calendar module 1 can also be coupled to a wheel of a clutch mechanism of the timepiece movement 3 in order to couple the correction of the time display 17 (usually the last pulled position of the crown 4) and the correction of at least one of the displays 16A, 16B, 16C, 16D, 16E of the calendar display device 11 (usually an intermediate pulled position of the crown 4). As an alternative or in addition, the correction of at least one of the displays 16A, 16B, 16C, 16D, 16E of the calendar display device 11 can comprise dedicated elements mounted only in the calendar module 1. In practice, in the scope of invention, the correction device 21 can be used to preserve the synchronisation of the various displays 16A, 16B, 16C, 16D, 16E, whereas a correction of one only could result in the loss of this synchronisation. Specific dedicated correctors could nevertheless be considered for particular situations.

As shown more clearly in the example of FIG. 1, the timepiece 2 comprises a calendar display device 11 having a date hand display 16A, a month hand display 16B, a year disc display 16C, a weekday hand display 16D and a moon phase disc display 16E. In the example shown on FIG. 1, the timepiece 2 further comprises a time hand display 17 (hours and minutes) usually mounted on the timepiece movement 3. Obviously, display types other than those described above can be considered such as a cylinder, a sphere, a strip, a ring, one or more hands respectively pointers or one or more discs in linear, continuous, discontinuous, intermittent or retrograde operating mode with semi-instantaneous or instantaneous jump and/or in combination with these types of listed display without departing from the scope of the invention.

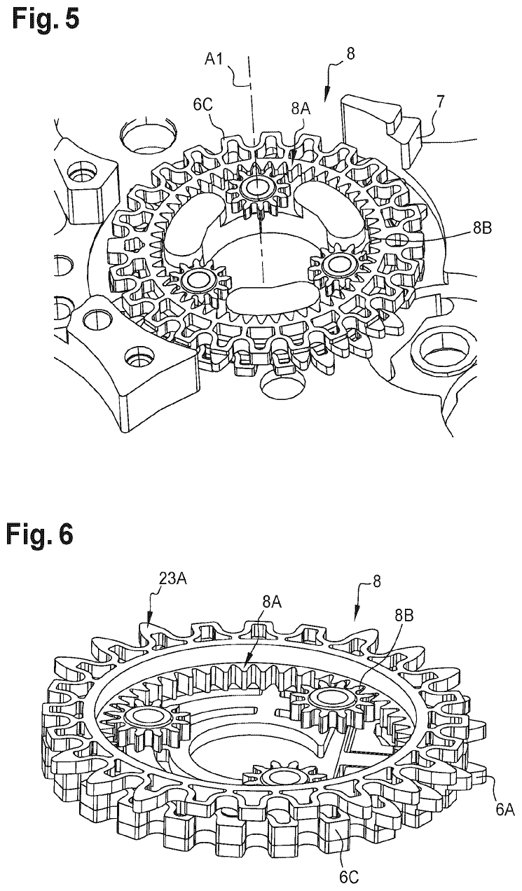

In the example shown on FIGS. 2-6, the force transmission mechanism 5 mainly comprises a reduction mechanism 8, a gear train 9, a date control pin 6A, a day control pin 6B and a month end control wheel 6C. The reduction mechanism 8 consists of an internal gear 8A of the month end control wheel 6C forming an external sun gear permanently coupled to three planet gears 8B mounted so as to pivot on the board 7. Preferably, the three planet gears 8B are permanently coupled to a pinion forming a central sun gear of an output shaft (not shown) of the timepiece movement 3 attached to the hour wheel. The reduction mechanism 8 can therefore be used to impose a rotation of the month end control wheel 6C every twenty-four hours around the first axis A1 at the centre of the board 7 of the calendar module 1.

The month end control wheel 6C is therefore the mechanical element which distributes the force received from the timepiece movement 3 to the rest of the force transmission mechanism 5. Typically, in the example shown on FIGS. 2, 4 and 6, the date control pin 6A is formed in the board of the wheel 9A of the gear train 9 which moves together with the month end control wheel 6C. As shown more clearly on FIGS. 4 and 6, the wheels 9A and 6C are stacked on top of each other. The date control pin 6A is intended, depending on its angle of rotation with respect to the first axis A1, to be temporarily coupled once a day with the date wheel 12 of a calendar display device 11 to increment by one unit the date display 16A every twenty-four hours during normal operation of the watch.

As shown more clearly in the example of FIG. 4, the date control pin 6A is elastically arranged on the wheel 9A in the force transmission mechanism 5 so that it can elastically retract towards the first axis A1 when it is subjected to a force greater than a predetermined value. The date control pin 6A thus comprises a body 6A1 oriented substantially radially and arranged in the wheel 9A by means of two flexible stems 6A2 substantially perpendicular each side of the body 6A1. In the rest position, the date control pin 6A projects from the periphery of the wheel 9A and can, when subjected to a force greater than a predetermined value (which is greater than the force required to drive the date wheel 12 during normal operation), elastically retract (by deformation of the stems 6A2) towards the first axis A1. Preferably, the pin 6A (and therefore the body 6A1), the flexible stems 6A2 and the wheel 9A are made in a single part obtained by adding material (3D printing, growth in a mould, etc.) or by removing material (mechanical machining, chemical etching, etc.).

In the example shown on FIG. 3, the month end control wheel 6C comprises a peripheral gear intended, depending on its angle of rotation with respect to the first axis A1, to be temporarily coupled at the ends of February, April, June, September and November to a month end wheel 13 of the calendar display device 11 to selectively increase by at least one additional unit the date display 16A depending on the number of days in the month.

In the example shown on FIGS. 2-6, the date display 16A is of the perpetual type, in other words it changes by two date units at the ends of April, June, September and November but also by four or three date units at the end of February depending on whether or not the year is a leap year. We therefore understand why the calendar display device 11 can also manage the displacements of the month 16B and year 16C displays by coupling the date wheel 12 to a dedicated gear train which will not be explained in more detail since using reduction gear trains, whose configuration is of known type from a rotation through three hundred and sixty degrees of the date wheel 12 every month.

In the example shown on FIGS. 2-4 and like the date control pin 6A, the day control pin 6B is formed in the board of the wheel 9B of the gear train 9. The wheel 9B is permanently coupled to the month end control wheel 6C using a setting wheel 9C. The day control pin 6B is intended, depending on its angle of rotation with respect to the second axis A2, to be temporarily coupled once a day with the day wheel 10 (seven-tooth star in the example of FIG. 3-4) of a calendar display device 11 to increment by one unit the weekday display 16D every twenty-four hours. We can also see that the gear train 9 is extended after the wheel 9B to drive, according to a reduction with respect to the wheel 9B, the moon phase display 16E. We therefore understand why the calendar display device 11 can also manage the displacements of the moon phase display 16E by coupling the wheel 9B to a dedicated gear train which will not be explained in more detail since using reduction gear trains, whose configuration is of known type from a rotation through three hundred and sixty degrees of the wheel 9B every day.

As shown more clearly in the example of FIGS. 3 and 4, and like the date control pin 6A, the day control pin 6B is elastically arranged on the wheel 9B in the force transmission mechanism 5 so that it can elastically retract towards the second axis A2 when it is subjected to a force greater than a predetermined value. The day control pin 6B thus comprises a body 6B1 oriented substantially radially and arranged in the wheel 9B by means of four flexible stems 6B2 substantially perpendicular each side of the body 6B1. In the rest position, the day control pin 6B projects from the periphery of the wheel 9B and can, when subjected to a force greater than a predetermined value (which is greater than the force required to drive the day star 10 during normal operation) to elastically retract (by deformation of the stems 6B2) towards the second axis A2. Preferably, the pin 6B (and therefore the body 6B1), the flexible stems 6B2 and the wheel 9B are made in a single part obtained by adding material (3D printing, growth in a mould, etc.) or by removing material (mechanical machining, chemical etching, etc.).

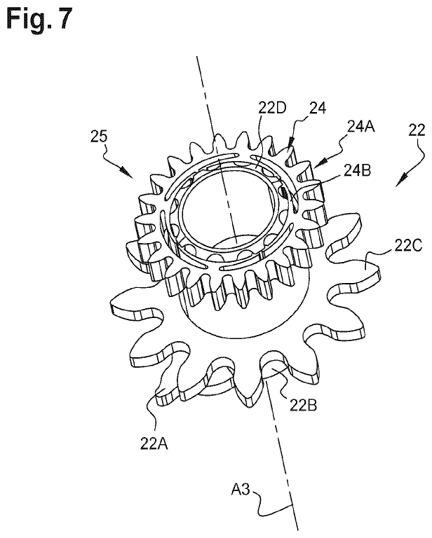

Advantageously according to the invention, the calendar module 1 comprises a device 21 for the bidirectional correction of at least two of the displays 16A, 16B, 16C, 16D, 16E and comprising the date display 16A of the display device 11. As shown in the example of FIGS. 4 and 7, the bidirectional correction device 21 comprises at least one correction mobile 22, arranged to control the date wheel 12 of the calendar display device 11 independently with respect to the force transmission mechanism 5 to avoid disturbing the latter during the correction phases.

In the example shown on FIGS. 4 and 7, the correction mobile 22 comprises a correction pin 22A formed in a first level of the correction mobile 22 and intended, depending on its angle of rotation with respect to the third axis A3, to be temporarily coupled every three hundred and sixty degrees with the date wheel 12 of the calendar display device 11 to correct the date display 16A by increasing or decreasing it without affecting the indexing of the force transmission mechanism 5 with respect to the calendar display device 11.

Thus, advantageously according to the invention, the correction system 21 does not act on the force transmission mechanism 5 coupled to the timepiece movement 3 as is generally the case, but has its own kinematic chain acting on the calendar display device 11 so that it can adapt to a very large variety of calendar modules 1 and in particular a large variety of calendar display complications. In addition, a given calendar module 1 can be mounted on different types of timepiece movement 3 to display calendar values. Lastly, the correction device 21 can be used to increase as well as decrease the value of the date display 16A.

As explained above, preferably according to the invention, the date control pin 6A can be elastically arranged in the force transmission mechanism 5 so that it can elastically retract from the date wheel 12 when the latter is moved by the correction pin 22A of the correction mobile 22 while the date control pin 6A is on the trajectory of the date wheel 12. This configuration provides a means of not preventing the correction between eleven p.m. and one a.m. every day. Although this function is not essential since corrections are rarely made at this time of night, it is proposed as an advantageous option of the invention.

In addition, in the example shown on FIGS. 3-7, the bidirectional correction device 21 comprises a correction gear train 23 permanently coupled to the correction mobile 22 and arranged to control the day wheel 10 (seven-tooth star in the example of FIG. 3-4) of the calendar display device 11 independently with respect to the force transmission mechanism 5 to avoid disturbing the latter during the correction phases.

More precisely, the correction gear train 23 mainly comprises a central wheel 23A and an end wheel 23B connected by intermediate setting wheels to a pinion 22C formed in a third level of the correction mobile 22. In the example shown on FIGS. 3-4, there is a setting wheel between the pinion 22C and the central wheel 23A which is coupled to the end wheel 23B by another setting wheel. However, this configuration of the gear train 23 can be adapted depending on the architecture of the calendar module 1 or of the timepiece movement 3 without departing from the scope of the invention.

In the example shown on FIGS. 3-4, the end wheel 23B comprises a plug 23B1 formed in excess thickness and intended, depending on the angle of rotation of the end wheel 23B, to be temporarily coupled every three hundred and sixty degrees to the day wheel 10 (seven-tooth star in the example of FIG. 3-4) of the calendar display 11 to correct the weekday display 16D (at the same time at least as the date display 16A) by increasing as well as decreasing it without affecting the indexing of the force transmission mechanism 5 with respect to the calendar display device 11. Advantageously according to the invention, the correction device 21 does not act on the force transmission mechanism 5 coupled to the timepiece movement 3 in the usual way but has its own kinematic chain acting on the calendar display device 11 to increase as well as decrease the value of the weekday display 16D and every other display 16E (moon) related to the weekday display 16D without desynchronising them.

As explained above, preferably according to the invention, the day control pin 6B is elastically arranged in the force transmission mechanism 5 so that it can elastically retract from the day wheel 10 when the latter is moved by the correction gear train 23 while the day control pin 6B is on the trajectory of the day wheel 10. Like the date control pin 6A, this configuration of the day control pin 6B provides a means of not preventing the correction between eleven p.m. and one a.m. every day. Although this function is not essential since corrections are rarely made at this time of night, it is proposed as an advantageous option of the invention.

Since the example shown on FIGS. 2-6 comprises a perpetual type date display 16A, the bidirectional correction device 21 uses the central wheel 23A of the correction gear train 23 to control the month end wheel 13 of the calendar display device 11 independently with respect to the force transmission mechanism 5 to avoid disturbing the latter during the correction phases. Advantageously according to the invention, even in this particular variant in which the calendar module 1 comprises a perpetual date display 16A, the correction system 21 does not act on the force transmission mechanism 5 coupled to the timepiece movement 3 in the usual way but has its own kinematic chain acting on the calendar display device 11 so that it can adapt to a very large variety of calendar modules 1. In addition, the correction device 21 can be used to increase as well as decrease the value of the date display 16A and of the other displays 16B (month), 16C (year) related to the perpetual date mechanism without desynchronising them.

According to an optional function, the correction mobile 22 can comprise an elastic force limitation mechanism 25 to elastically disengage the correction movement bidirectionally above a predetermined torque applied to the correction mobile 22 so that in particular the correction gear train 23 does not drive the month end wheel 13 of the calendar display device 11 while the month end control wheel 6C is meshed with the month end wheel 13 of the calendar display device 11. This configuration avoids damaging the timepiece movement 3 by allowing the correction to be disengaged between midnight and three a.m. at the ends of February, April, June, September and November. Although this function is not essential (correction is not possible as resistance to the correction is encountered due to the month end control wheel 6C which is meshed with the month end wheel 13 of the calendar display device 11) since corrections are rarely made at this time of night, it is proposed as an advantageous option of the invention which dissuades the user from forcing the control member 4 such as the crown in the example of FIG. 1.

More precisely, in the example shown on FIG. 7, the elastic force limitation mechanism 25 comprises a flute 22D on the periphery of a fourth level of the correction mobile 22 and a wheel 24 cooperating with the flute 22D. The wheel 24 comprises a peripheral gear 24A intended to receive, when the correction device 21 is in the engaged position, the correction force that the user exerts on the correction control member 4 such as the crown in the intermediate position in the example of FIG. 1. The wheel 24 comprises elastic elements 24b distributed around its inner diameter and having ends intended to come into contact with the flute 22D.

In the example of FIG. 7, the elastic elements 24b extend in the form of four Y-shaped parts symmetrically distributed around the third axis A3. Below the predetermined torque applied, the wheel 24 is elastically in a stable position and integral in rotation with the flute 22D. Above the predetermined torque applied, the wheel 24 is elastically uncoupled and can no longer transmit force to the flute 22D and the wheel 24 rotates about the third axis A3. Lastly, as soon as the force is released to drop again below the predetermined torque, the elastic elements 24b return to a stable elastic position against the flute 22D, once again making the wheel 24 integral in rotation with the flute 22D.

Preferably, and taking into account the forces exerted by the user on the control member 4, the elastic force limitation mechanism 25 comprises a predetermined disengagement torque that is identical for each direction of rotation about the third axis A3 and typically between 3 and 5 Nmm, typically substantially equal to 4 Nmm (which is greater than the force required to drive the date wheel 12, the month end wheel 13 and the day wheel 10 during normal correction operation and which is also greater than the force required to elastically retract the pins 6A, 6B). Obviously, however, the predetermined disengagement torque could be different depending on the direction of rotation about the third axis A3 by adapting the shape of the elastic elements 24b and/or each predetermined disengagement torque could be greater than or less than 4 Nmm without departing from the scope of the invention.

Lastly, the correction device 21 can, optionally, comprise a cam 22b—elastic element 26 assembly allowing, in the disengaged position of the bidirectional correction device 21, the correction mobile 22 to be in a predetermined rest position outside the trajectory of the date wheel 12. We therefore understand that, in the disengaged position, the correction mobile 22 is still in the same rest position, for example to provide an equivalent displacement for the increase (first direction of movement) as for the decrease (second direction of movement opposite to the first direction) of the value of the calendar display 16A, 16B, 16C, 16D, 16E. In the example shown on FIGS. 3 and 4, the cam 22b is mounted in a second level of the correction mobile 22. In addition, the elastic element 26 is mounted on a fixed part (the board 7 using screws) of the calendar module 1, and exerts a thrust force against an external profile of the cam 22B. The shape of the elastic element 26 in contact with the cam 22B, as well as the shape of the latter, are determined so as to drive, in the disengaged position of the bidirectional correction device 21, the correction mobile 22 to its predetermined rest position.

The invention is not limited to the embodiments and variants described and other embodiments and variants will be clearly apparent to those skilled in the art. The above embodiments are therefore examples. As a non-limiting example, more complicated or simpler displays could be considered without departing from the scope of the invention.

In addition, as explained above, the correction device 21 cannot be limited to an installation in a calendar module 1. The correction device 21 therefore applies to an installation in a timepiece movement 3 in general, without departing from the scope of the invention.

1. A device for a bidirectional correction of at least two displays including a date display of a calendar display device having a correction mobile and a correction gear train permanently coupled to the correction mobile that are arranged to simultaneously correct the at least two displays of the calendar display device independently with respect to a force transmission mechanism of the at least two displays intended to increment them periodically in order to preserve the synchronisation of the at least two displays of the calendar display device during the correction phases.

2. A timepiece movement comprising the device for the bidirectional correction of the display device according to claim 1, the timepiece movement having the force transmission mechanism comprising a date control pin arranged to control a date wheel of the calendar display device to increment by one unit the date display every twenty-four hours, wherein the correction mobile of the bidirectional correction device is arranged to control the date wheel of the calendar display device independently with respect to the force transmission mechanism to avoid disturbing the force transmission mechanism during the correction phases.

3. The timepiece movement according to claim 2, wherein the date control pin is elastically arranged in the force transmission mechanism so that it can elastically retract from the date wheel when the date wheel is moved by the correction mobile while the date control pin is on a trajectory of the date wheel.

4. The timepiece movement according to claim 3, wherein the force transmission mechanism comprises a day control pin arranged to control a day wheel of the calendar display device to increment by one unit at least one day display every twenty-four hours, the correction gear train of the bidirectional correction device being arranged to control the day wheel of the calendar display device independently with respect to the force transmission mechanism to avoid disturbing the force transmission mechanism during the correction phases.

5. The timepiece movement according to claim 4, wherein the day control pin is elastically arranged in the force transmission mechanism so that it can elastically retract from the day wheel when the day wheel is moved by the correction gear train while the day control pin is on a trajectory of the day wheel.

6. The timepiece movement according to claim 5, wherein the force transmission mechanism comprises a month end control wheel arranged to control a month end wheel of the calendar display device to selectively increment by at least one additional unit the date display depending on a number of days in the month, the correction gear train of the bidirectional correction device being arranged to control the month end wheel of the calendar display device independently with respect to the force transmission mechanism to avoid disturbing the force transmission mechanism during the correction phases.

7. The timepiece movement according to claim 6, wherein the correction mobile comprises an elastic force limitation mechanism to elastically disengage the correction movement bidirectionally above a predetermined torque applied to the correction mobile so that the correction gear train does not drive the month end wheel of the calendar display device while the month end control wheel is meshed with the month end wheel of the calendar display device.

8. The timepiece movement according to claim 7, wherein the bidirectional correction device comprises a clutch mechanism to switch between a correction position in which the correction device is coupled to a correction control member to correct the display device bidirectionally, and a disengaged position in which the correction device is uncoupled from the control member to prevent any correction of the display device.

9. The timepiece movement according to claim 8, wherein the correction device comprises a cam and an elastic element allowing, in the disengaged position, the correction mobile to be in a predetermined rest position outside a trajectory of the date wheel.

10. The timepiece movement according to claim 9, wherein the cam is mounted on the correction mobile and the elastic element, mounted on a fixed part of the timepiece movement, exerts a thrust force against an external profile of the cam to drive, in the disengaged position, the correction mobile to its predetermined rest position.

11. A timepiece comprising the timepiece movement according to claim 2.

12. The timepiece movement according to claim 2, wherein the force transmission mechanism comprises a day control pin arranged to control a day wheel of the calendar display device to increment by one unit at least one day display every twenty-four hours, the correction gear train of the bidirectional correction device being arranged to control the day wheel of the calendar display device independently with respect to the force transmission mechanism to avoid disturbing the force transmission mechanism during the correction phases.

13. The timepiece movement according to claim 2, wherein the force transmission mechanism comprises a month end control wheel arranged to control a month end wheel of the calendar display device to selectively increment by at least one additional unit the date display depending on a number of days in the month, the correction gear train of the bidirectional correction device being arranged to control the month end wheel of the calendar display device independently with respect to the force transmission mechanism to avoid disturbing the force transmission mechanism during the correction phases.

14. The timepiece movement according to claim 2, wherein the bidirectional correction device comprises a clutch mechanism to switch between a correction position in which the correction device is coupled to a correction control member to correct the display device bidirectionally, and a disengaged position in which the correction device is uncoupled from the control member to prevent any correction of the display device.
